(19) United States
(12) Patent Application Publication
(10) Pub. No.: US 2005/0031314 A1
(43) Pub. Date: Feb. 10, 2005

(54) System and method for dissemination of audio-visual program information

(76) Inventor: Alvaro Galdos, El Paso, TX (US)

Correspondence Address: Augustine M. Rodriguez, Esq.;Rodriguez Law Firm, Ste. 211, 500 Oak St., NE, Albuquerque, NM, 87106, US

(21) Appl. No.: 10/635,326

(22) Filed: Aug. 5, 2003

(51) Int. Cl. H04N 5/76; H04N 5/225

(52) U.S. Cl. 386/117; 348/207.99

(57) ABSTRACT

A novel system and method for the dissemination of audio-visual program information such as, but not limited to advertisements, safety procedures, directions and/or menus. More particularly, the present invention relates to a low-cost alternative to a internet server or satellite based information disseminating system as a means for providing information to a targeted audience. The audio-visual program information dissemination system stores pre-programmed information on a digital video disc for subsequent dissemination on a plurality of individual display devices located in public and/or private venues which are fed a continuous stream of information for the targeted audience. The digitized audio-visual program information images are displayed intermittently, before cycling to the next image, creating an electronic billboard.

### BACKGROUND OF THE INVENTION

1. Field of the Invention (Technical Field)

The present invention relates generally to a system and method for the dissemination of information such as, but not limited to advertisements, safety procedures, directions and/or menus. More particularly, the present invention relates to a low-cost alternative to a internet server or satellite based information disseminating system as a means for providing information to a targeted audience. The information dissemination system and method includes a scanning device, such as but not limited to a digitizer for digitizing information, a programming device for storing the digitized information on a laser-read storage medium, such as a digital video disc (DVD), a base decoder and transmitter device, such as but not limited to a DVD player or DVD read/write drive, and a plurality of individual display devices, such as but not limited to plasma screen monitors, that are located in public and/or private venues which are fed a continuous stream of information that is pre-programmed for the targeted audience. The digitized information is recorded on an optical, laser read disc so that when it is played back, the system displays each of the images intermittently, before cycling to the next image, creating an electronic billboard.

2. Background Art

Present day out-of-home program delivering networks rely substantially on high priced internet based servers, cable programming and digital satellite and/or direct broadcast satellite (“DSS/DBS”) systems. Many of the currently available systems require, large up-front financial commitments, expensive computer and telecommunications infrastructures, dedicated maintenance personnel, high speed transmission lines or satellite links, plus the added possibility of major system breakdowns due to the multitude of different pieces of equipment required. These systems also require on-going and expensive methods of content creation using only sophisticated commercial video production organizations. The limitations place dynamic advertising out of reach of most local restaurants, manufacturers and retailers, moreover, cannot be made available to mobile or portable systems which may be utilized in taxicabs or passenger buses.

The present invention overcomes these limitations by providing for the viewing and listening of information and/or advertising program without the up-front financial commitment of costly internet network servers or satellite systems. The information and/or advertising dissemination system of the present invention, can be utilized for disseminating information within desired areas of any public or private entity such as local restaurants, manufacturers, retailers, airports, schools and/or mobile or portable units in taxi cabs or buses. Programmed information may be transmitted and/or broadcast from the base transmitter with multiple outputs, such as but not limited to a DVD player or DVDrom drive on a computer, to a plurality of display devices. The invention dispenses of all the costs, complications and limitations associated with internet networks and satellite systems as are evident in the prior art.

Many systems for the delivering of an audio-visual program have been developed and are present in the prior art. For example, U.S. Pat. No. 6,408,278 to Carney, et al., entitled System and Method for Delivering Out-of-Home Programming, discloses a system and method that utilizes an internet based network system to deliver and track demographic data for the purposes of conforming programming content to the changing demographic. The Carney et al., patent requires costly internet servers to manage the system. The present invention is distinguished from Carney et al., because the present invention utilizes the base transmitter unit to broadcast an available audio-video program to a plurality of display devices. The programming content is pre-determined and targeted according to the needs of the individual entity that is disseminating the information and/or advertising. In addition, the present invention goes further by providing the option of including audio information to the primary visual program.

Another patent, issued to de Hond, U.S. Pat. No. 5,737,533 entitled System for Generating a Virtual Reality Scene in Response to a Database Search, discloses the use of a server to present a graphical user interface by which information is disseminated to its clients. The Hayes et al., invention also allows the client to interface through multiple display devices, with its database and conduct searches. The present invention varies from the de Hond, patent in that the present invention does not provide an interface nor is it dependent on a costly network.

U.S. Pat. No. 5,612,741 entitled Video Billboard, issued to Loban, et al., discloses a video billboard system with a plurality of projection units interfaced with a remote master transmitter. A significant distinction of the Loban, et al. patent is that it describes the use of a computer video control system linked via landline, cellular phone, satellite relay or other wireless communication links to a plurality of video billboards. Again the reliance on costly communications equipment distinguishes Loban et al., from the present invention.

Other programming delivery system patents, such as U.S. Pat. No. 5,1333,081, entitled Remotely Controllable Message Broadcast System Including Central Programming Station, Remote Message Transmitters and Repeaters, issued to Mayo, and U.S. Pat. No. 5,309,355, entitled Automated Sales System, issued to Lockwood, both disclose remotely controllable message systems. Mayo for example, utilizes a broadcast system to transmit audio and digital video programming to a plurality of receivers. Lockwood on the other hand, uses an apparatus to customize sales presentations to promote travel packages through an audio-visual presentation. Both are distinguished from the present invention, in that neither patent discloses the use of a pre-programmed storage devices such as a Digital Video Disc (“DVD”) and a dedicated base transmitter system that distributes the programming to a plurality of display devices as in the present invention.

While other distinctions between the prior art and the present invention, not specifically addressed here, may be evident to those skilled in the art, it is clear that the aforementioned prior art patents do not describe a system and method of providing a pre-programmed storage medium, such as a Digital Video Disc that allows the user to set the system for viewing directly from a DVD player electronically connected to a plurality of display units which cycle audio-visual image information intermittently to inform the intended audience. The above-discussed and other drawbacks and deficiencies of the prior art, the teachings of which are hereby incorporated by reference, are overcome by the present invention.

### SUMMARY OF THE INVENTION

The present invention overcomes the foregoing disadvantages of the prior art by providing a novel system for the dissemination of information, such as but not limited to advertisements, safety procedures, directions and/or menus. According to the invention, there is provided a method for the dissemination of an audio-visual program information on a laser-read, optical storage medium, such as a digital video disc that is utilized as a storage medium for the information that is to be disseminated. The information is digitized and recorded on a laser-read video disc so that when it is played back, the system intermittently displays each of the audio-visual image information, pausing for a pre-determined amount of time before cycling to the next image. The plurality of display devices create an electronic billboard that intermittently displays the desired information, so as to cycle through all of the information that is to be disseminated. The general purpose of the invention is to provide the above described new and improved system and method of disseminating information, comprised of digitized information stored on an laser-read, video disc, that is played on a digital video disc player and electronically transmitted to a plurality of display devices, strategically located to reach the target audience, having all of the advantages of the prior art and none of the disadvantages.

To achieve the advantages over the prior art, the present invention may be embodied by a digitizer device that scans and digitizes information and/or reformats digital information to be compatible with the digital video disc storage medium, a programming device that records the digitized information on the digital video disc storage medium, a digital video disc player device to decode and transmit the audio and video image information, and a plurality of display devices to display and disseminate the information. The programming device is embodied by a computer system with audio-visual digitizing software, known in the art, for creating the desired programming and a DVD read and write drive for storing the programming on a digital video disc. The digitizer device is embodied by a scanning device, which is electronically connected to the programming device, equipped with digitizing software to digitize the information in a format compatible with that required by the programming device.

An advantage and aspect of the invention is the use of a DVD player device electronically connected to a plurality of display devices (e.g. a cathode ray tube, a liquid crystal display, a plasma liquid crystal display, etc.) for disseminating the programming in a relatively inexpensive manner when compared to the cost of an internet server or satellite based systems. The programming is saved on a digital video disc that can be inexpensively duplicated and distributed to the location where the information is to be disseminated.

Additional advantages and aspects of the present invention may include, for example the use of an advertising agency to create an advertising campaign, digitally which can be saved on a digital video disc and is ready for distribution to all locations already equipped with the devices required for the dissemination of the information according to the present invention.

Other aspects, advantages and novel features, and further scope of applicability of the present invention will be set forth in part in the detailed description to follow, taken in conjunction with the accompanying drawings and in part, will become apparent to those skilled in the art upon examination of the following, or may be learned by the practice of the invention. The aspects and advantages of the invention may also be realized and attained by means of the instrumentalities and combinations particularly pointed out in the appended claims.

### BRIEF DESCRIPTION OF THE FIGURES

The accompanying drawings, which are incorporated into and form a part of the specification, illustrate several embodiments of the present invention, and together with the description, serve to explain the principles of the invention. The drawings are only for the purpose of illustrating preferred embodiments of the invention and are not to be construed as limiting the invention. In the drawings:

FIG. 1 is a block diagram illustrating a system embodying the invention;

FIG. 2 is a block diagram illustrating an alternative system embodying the invention; and

FIG. 3 is a flowchart illustrating operation of the system of FIG. 1.

### DESCRIPTION OF THE PREFERRED EMBODIMENTS (BEST MODES FOR CARRYING OUT THE INVENTION)

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally relates to apparatuses and methods to provide a novel information dissemination system and method as a means for providing information such as, but not limited to advertisements, safety procedures, directions and/or menus to a targeted audience. The preferred embodiment is particularly well suited to provide a low-cost, easily implemented system to disseminate information through an audio and video program. Using the drawings, the preferred embodiments of the present invention will now be explained.

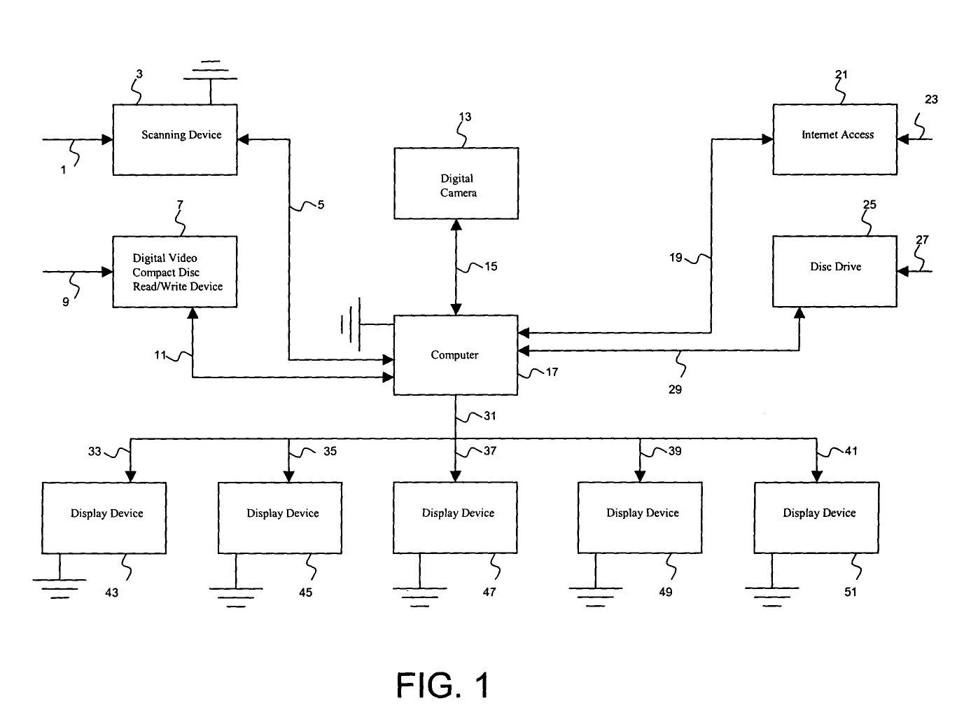

Referring now to FIG. 1, which shows an embodiment of the present invention by way of example, is practiced by interfacing electronically coupled components of the information dissemination system and method. The electronically coupled components, interfacing through electrical couplings 5, 11, 15,19, 29 and 31 include a scanning device 3, such as but not limited to a digitizer for digitizing image 1 information, a digital video disc read/write drive 7 for storing the digitized information on a laser-read storage medium, such as a digital video disc 9, a programmable computing device, such as but not limited to a computer 17, a disc drive 25, for reading/writing information off of floppy disc 27, a plurality of individual display devices 43,45,47,49 and 51, preferably plasma screen monitors, interfacing with computer 17 through electrical couplings 31, 33, 35, 37, 39 and 41, internet access means 21 to download digitized image 23 information and software means on computer 17 to create content slides and digital video discs for distribution.

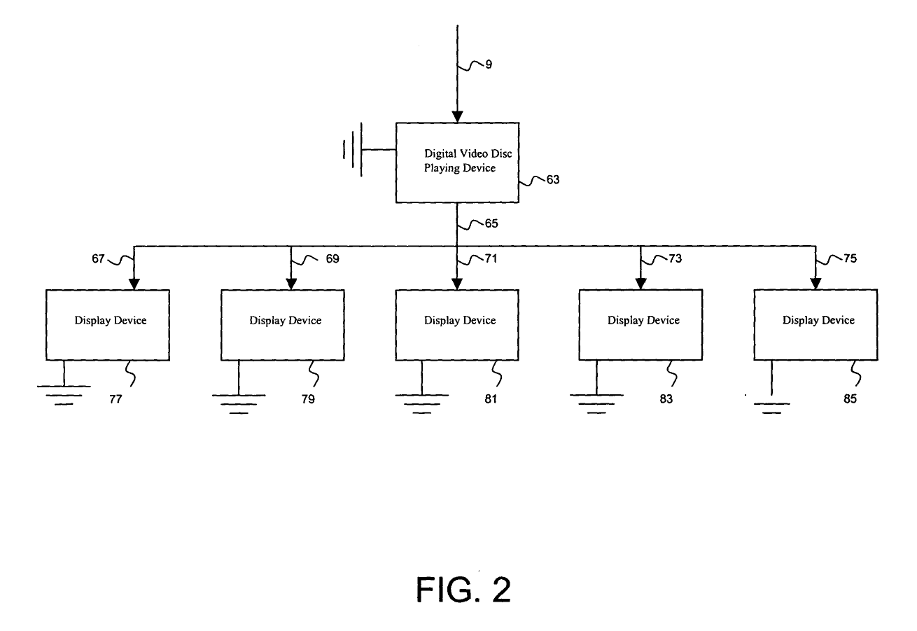

FIG. 2 illustrates an alternative embodiment of the present invention. As shown on FIG. 2, once the information is programed and saved on the digital video disc 9, multiple copies of the digital video disc 9 can be made and distributed inexpensively to other users whom have implemented an information dissemination system as illustrated in FIG. 2, which is composed of digital video disc playing device 63 interfaced with a plurality of display devices 77,79,81,83 and 85 through electrical couplings 65, 67, 69, 71, 73, and 75 dispersed according to the particularized requirements for disseminating such information.

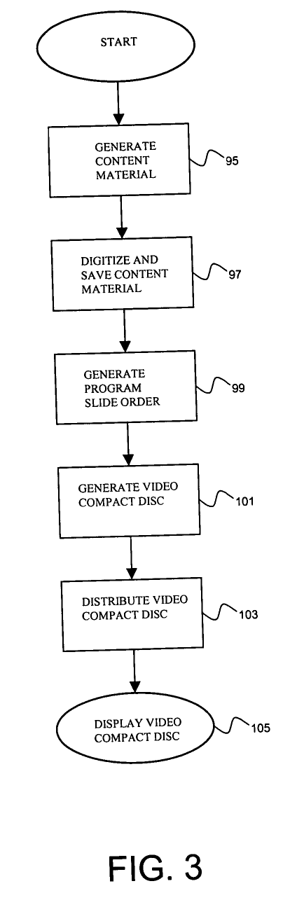

Turning to FIG. 3, illustrating a block diagram of the configuration of an embodiment of the method of utilizing the present invention. According to the invention, at step 95, the user generates the content material which comprises the information to be disseminated. At step 95, the user may acquire the content material from multiple sources, such as but not limited to scanning device 3, internet access 21, disc drive 25, digital video disc read/write drive 7 or digital camera 13. At step 97, the user digitizes the content material with digitizing software loaded on computer 17, such as but not limited to Adober™, Photoshop™, PhotoDeluxe™, Photoshop Elements™, Paintshop Pro™ and Microsoft Powerpoint™ to generate individual JPEG-formatted content file templates containing recurring information. The files also include the company name or logo and will be saved on computer 17's hard drive. At step 99, the user utilizes software such as, but not limited to Xatshow™, allowing the user to easily insert the content slides in the order to be presented. Xatshow™ is then utilized in conjunction with CD recording software such as, but not limited to Roxio's™, and/or Easy CD Creator™ to save (i.e. D.V.D. “burning”) the program information onto of the digital video disc 9. Moreover at step 99, the user may add audio programming to the slide templates, as well as determine the aspect ratio of either normal (4:3) or extended (16:9), the order of the slide templates and the cycle timing of the slide templates in order to display the audio-visual content material image intermittently. At step 101, the user generates a digital video disc 9 by utilizing the write function of the digital video disc read/write device 7 to save the generated information for dissemination. At step 103, the user can make (i.e. “burn”) copies and distribute the digital video disc 9 to any location at which the user intends to disseminate the information. At step 105, the user utilizes digital video disc read/write device 7 or digital video disc playing device 63 to disseminate the programmed information on the electronically coupled plurality of display devices.

Applicability:

The invention is further illustrated by the following non-limiting example. Other examples will be apparent to those skilled in the art. It should be noted that same components as those in each of the figures and examples of the present invention are represented by the same reference numerals for the purpose of convenience.

### EXAMPLE 1

A typical information dissemination system, usually described as out-of-home program delivering networks rely substantially on high priced internet based servers, cable programming, and digital satellite and/or direct broadcast satellite (“DSS/DBS”) systems. The present invention provides a low-cost alternative to these systems. As non-limiting example, for a user that wants to disseminate advertisement information at a small retail location would utilize the present invention as is described in FIG. 1 herein. The user can utilize digital camera 13 to take pictures of the items of merchandise the user seeks to advertise, according to step 95. The digital camera 13 is interfaced with computer 17 through electrical coupling 15 on which the digital photographs are saved onto computer 17's hard disc drive, according to step 97. The user then generates JPEG-formatted slide templates with the user's retail store name and logo, the image of the merchandise and its price, according to step 99. Moreover, the user orders the JPEG-formatted slide templates in the sequence of choice and audio programming is added. The user then uses interfaced computer 17 to save (i.e. “burns”) the JPEG-formatted slide templates onto a digital video disc 9 with digital video disc read/write device 7, through electrical coupling 11, according to step 101. According to step 103, the user can utilize the sales campaign saved onto digital video disc 9 to advertise the merchandise on the plurality of display devices dispersed within the user's retail store location according to step 105.

### EXAMPLE 2

The invention is not limited to the advertisement of merchandise, but can be utilized at other locations where the use of a dedicated satellite system or computer server system is impractical. For example, a manufacturing company can disperse safety information to employees economically, by locating a plurality of display devices where safety information is critical. In such an instance, JPEG-formatted slide templates may include content material with information for employees such as but not limited to egress instructions, safety procedures and hazard warnings.

Although the invention has been described in detail with particular reference to these preferred embodiments, other embodiments can achieve the same results. Other alterations to the above described embodiments of the invention will be readily apparent to those ordinarily skilled in the art and is intended, therefore, that all such modifications and equivalents are to be embraced within the spirit and scope of the present invention and the appended claims. In addition, the entire disclosures of all references, applications, patents and publications cited above are hereby incorporated by reference.

1. An audio-visual program information dissemination system, said system comprising:
a personal computer;
a plurality of geographically dispersed display devices electronically coupled with said personal computer; and
a plurality of digital data gathering devices electronically coupled with said personal computer.

2. The audio-visual program information dissemination system as recited in claim 1, wherein the digital data gathering device is a digital camera.

3. The audio-visual program information dissemination system as recited in claim 1, wherein the digital data gathering device is a scanner.

4. The audio-visual program information dissemination system as recited in claim 1, wherein the digital data gathering device is a digital video disc read/write drive.

5. The audio-visual program information dissemination system as recited in claim 1, wherein the digital data gathering device is internet access.

6. The audio-visual program information dissemination system as recited in claim 1, wherein the digital data gathering device is a floppy disc drive.

7. The audio-visual program information dissemination system as recited in claim 1, wherein the display device is a cathode ray tube.

8. The audio-visual program information dissemination system as recited in claim 1, wherein the display device is a liquid crystal display.

9. The audio-visual program information dissemination system as recited in claim 1, wherein the display device is a plasma liquid crystal display.

10. The audio-visual program information dissemination system according to claim 1 wherein said system, further comprises:
means for digitizing content material images;
means for adding audio to the content material images;
means for generating JPEG-formatted slide templates;
means for controlling the aspect ratio of the content material images;
means for controlling the time lapse between images of content material; and
means for anti-flicker filtering of the images of content material.

11. The information dissemination system as recited in claim 10, wherein the content material is digitalized information comprised of advertisements, safety procedures, directions and menus.

12. An audio-visual program information dissemination system, said system comprising:
a digital video disc player; and
a plurality of geographically dispersed display devices electronically coupled with said digital video disc player.

13. A method for disseminating audio-visual program information, comprising the acts of:
determining content material to be disseminated;
digitizing content material images on a personal computer;
generating JPEG-formatted slide templates on said personal computer;
combining said content material images within said JPEG-formatted slide templates on said personal computer;
setting the aspect ratio of the said combined content material images on said personal computer;
setting the time lapse between said combined content material images on said personal computer;
setting the order of said combined content material images on said personal computer;
saving the combined content material images on a plurality of digital video discs with a digital video disc read/write drive of said personal computer; and
distributing said digital video discs to a plurality of video display devices electronically coupled with said personal computer.

14. A method for disseminating audio-visual program information, as recited in claim 13, including the step of adding an audio program to the combined content material images;

15. A method for disseminating audio-visual program information, as recited in claim 13, wherein said digital video discs are played on a digital video disc player electronically coupled to a plurality of video display devices.
